(19) United States
(12) Patent Application Publication
(10) Pub. No.: US 2022/0109173 A1
(43) Pub. Date: Apr. 7, 2022

(54) Hydrogen Based Renewable Energy Storage System

(71) Applicant: Rodolfo Antonio Gomez, South Australia (AU)

(72) Inventor: Rodolfo Antonio Gomez, South Australia (AU)

(21) Appl. No.: 17/429,654

(22) PCT Filed: Feb. 11, 2020
(86) PCT No.: PCT/AU2020/000013

§ 371 Date: Aug. 10, 2021

(30) Foreign Application Priority Data
Feb. 11, 2019 (AU) 2019900426

(51) Int. Cl. H01M 8/0656; H01M 8/04082; C25B 1/04

(52) U.S. Cl. CPC H01M 8/0656; C25B 1/04; H01M 8/04201

(57) ABSTRACT

A renewable energy storage system which uses hydrogen as a storage medium. The system includes a hydrogen generation module for producing hydrogen through electrolysis of water, with the hydrogen generation module powered by one or more renewable energy sources, and a hydrogen storage module for storing at least part of the hydrogen as compressed hydrogen or as hydrogen protons. The system further includes a hydrogen fuel cell for converting at least part of the hydrogen stored to produce electricity.

### CROSS-REFERENCE TO RELATED APPLICATIONS

This application is the United States national phase of International Application No. PCT/AU2020/000013 filed Feb. 11, 2020, and claims priority to Australian Provisional Patent Application No. 2019900426 filed Feb. 11, 2019, the disclosures of which are hereby incorporated by reference in their entirety.

### INCORPORATION BY REFERENCE

The following publications are referred to in the present application and their contents are hereby incorporated by reference in their entirety:
U.S. Pat. No. 10,316,416 titled “Diaphragm type electrolytic cell and a process for the production of hydrogen from unipolar electrolysis of water” in the name of Rodolfo Antonio M. Gomez,
Australia Patent 2007257247 titled “Electrolytic activation of water” in the name of Rodolfo Antonio M. Gomez,
U.S. Pat. No. 7,326,329 titled “Commercial Production of Hydrogen from Water” in the name of Rodolfo Antonio M. Gomez,
PCT application titled “Advanced Electrolytic Storage and Recovery of Hydrogen” in the name of Rodolfo Antonio M. Gomez,
U.S. Pat. No. 6,475,653 titled “Non diffusion fuel cell and a process of using the fuel cell” in the name of RMG SERVICES PTY LTD,

The content of each of these applications is hereby incorporated by reference in their entirety.

### BACKGROUND OF THE INVENTION

### Field of the Invention

The present invention relates to an energy storage system for storing renewable energy which uses hydrogen as a medium. The present invention also relates to a method of storing and releasing renewable energy in grid scale by use of hydrogen as a medium.

### Description of Related Art

The world is increasing its use of renewable energy such as solar and wind energy to replace electricity produced from fossil fuels such as coal and natural gas power plants as a response to global warming. The methods so far used to provide electricity when the sun is not shining or when the wind is not blowing include:
1. Coal and natural gas power plants. However, these result in higher cost because the cost of operating the coal or gas power plants are added to the cost of the solar or wind power plants, and also carbon emissions are not reduced.
2. Pump Hydro. A tried and tested method. For this method, water is pumped to an elevated reservoir when excess solar or wind electricity is available, and when the electricity is required, the stored water is passed through water turbines to produce electricity. Pump hydro rated at 2,000 MW is installed at the Snowy Mountains, NSW in Australia. Unfortunately, the right geography and water availability are not generally available where required.
3. Lithium Ion Batteries. Advances in the development of the lithium ion batteries for use in automobiles have made possible the installation of large lithium ion batteries to store energy for solar or wind power plants. The first major lithium ion battery of grid scale size is at the Jamestown wind farm at Jamestown, South Australia with a capacity of 100 megawatts. Unfortunately, this lithium ion battery can only provide about 1.2 hours of storage at the battery capacity.

To advance the use of desirable renewable energy such as solar energy and wind energy, an efficient energy storage with higher capacity is required. Compared to a lithium ion battery which has an energy density of 0.3 to 0.86 mega-joules per kilogram (MJ/kg), hydrogen has an energy density of 142 MJ/kg. FIG. 1 is a graph showing the energy densities of several energy storage systems given by Dr. C. E. Thomas of HyGen Innovations, Inc. 2009. It is clear from FIG. 1 that the lithium ion battery has an energy density of about 150 Wh/kg while compressed hydrogen at 5,000 psi including the weight of the storage and fuel cell is about 585 Wh/kg.

There is thus a need to provide an efficient storage and release system for renewable energy at grid scale.

### SUMMARY OF THE INVENTION

The present inventor has developed a renewable energy storage system which uses hydrogen as a storage medium. The renewable energy storage system is capable of being used as a grid scale energy storage system. In the system, at least part of any renewable energy (e.g. solar, wind and/or wave) that is generated is used for electrolyzing water to produce hydrogen. The hydrogen is stored and is accessed when required. Optionally, the stored hydrogen can be transported. The hydrogen is then used to generate electricity which can be supplied to the grid as required.

In a first aspect, there is provided a renewable energy storage system which uses hydrogen as a storage medium, the system comprising:

a hydrogen generation module for producing hydrogen through electrolysis of water wherein the hydrogen generation module is powered by one or more renewable energy sources;

a hydrogen storage module for storing at least part of the hydrogen as compressed hydrogen or as hydrogen protons; and

a generation module for producing electricity from the hydrogen or protons after they have been converted to hydrogen.

In a second aspect, there is provided a grid scale renewable energy storage system which uses hydrogen as a storage medium, the system comprising:

a hydrogen generation module for producing hydrogen through electrolysis of water wherein the hydrogen generation module is powered by one or more renewable energy sources;

a hydrogen storage module for storing at least part of the hydrogen as compressed hydrogen or as hydrogen protons; and

a generation module for producing electricity from the hydrogen or protons after they have been converted to hydrogen, wherein the generation module is in electrical communication with an electrical grid network.

In a third aspect, there is provided a method of storing renewable energy by use of hydrogen as a medium, which comprises:

producing hydrogen by electrolysis of water and with the use of renewable energy; and

storing at least part of the hydrogen as compressed hydrogen or hydrogen protons.

The method may also comprise converting at least part of the stored hydrogen or protons after they have been converted to hydrogen to produce electricity.

The generation module may be a hydrogen fuel cell.

### BRIEF DESCRIPTION OF DRAWINGS

Embodiments of the present disclosure will be discussed with reference to the accompanying drawings wherein:

FIG. 1 is a graph showing the energy densities of several energy storage systems given by Dr. C. E. Thomas of HyGen Innovations, Inc., 2009;

FIG. 2 is a diagram of a renewable energy storage system as described herein;

FIG. 3 is a diagram of an embodiment of a grid scale renewable energy storage system as described herein;

FIG. 4 is a diagram of an embodiment of a grid scale renewable energy storage system as described herein for generating continuous renewable electric power to the grid for solar/wind plants; and

FIG. 5 is a diagram of an embodiment of a renewable energy storage system as described herein for transport of hydrogen.

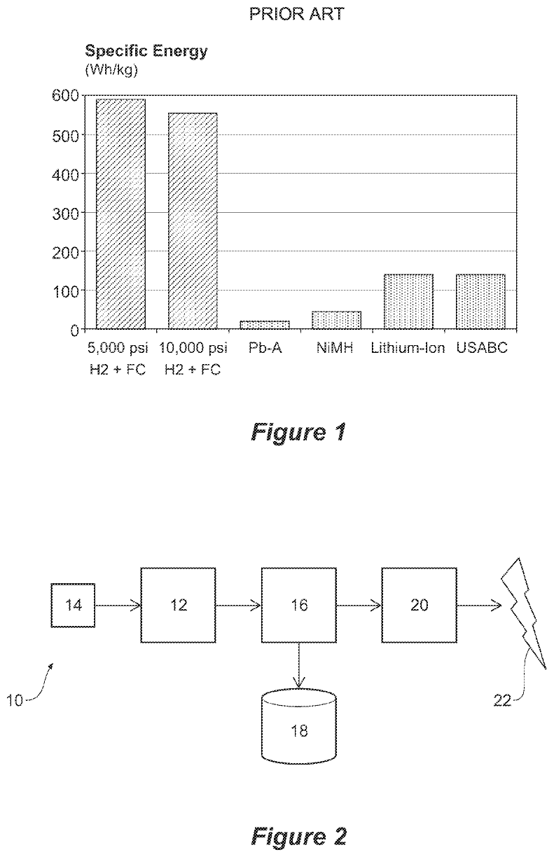

### DESCRIPTION OF THE INVENTION

Disclosed in FIGS. 2 to 5 is a renewable energy storage system 10 which uses hydrogen as a storage medium. The system 10 comprises a hydrogen generation module 12 for producing hydrogen through electrolysis of water. The hydrogen generation module 12 is powered by one or more renewable energy sources 14. The system 10 also comprises a hydrogen storage module 16 for storing at least part of the hydrogen as compressed hydrogen or as hydrogen protons. When the hydrogen is stored as compressed hydrogen or hydrogen protons, it may be suitable for transport via a transport unit 18 from one location to another location where the compressed hydrogen can be used for any one or more of a range of uses, such as a fuel or to produce electricity. As an alternative, when the hydrogen is stored as compressed hydrogen or hydrogen protons, it can be used to generate electricity. The system 10 also comprises a generation module 20 for producing electricity 22 from the hydrogen or protons after they have been converted to hydrogen.

The renewable energy storage system 10 may be a grid scale renewable energy storage system. Thus, certain embodiments provide a grid scale renewable energy storage system 10 which uses hydrogen as a storage medium. The system 10 comprises a hydrogen generation module 12 producing hydrogen through electrolysis of water. The hydrogen generation module 12 is powered by one or more renewable energy sources 14. The system 10 also comprises a hydrogen storage module 16 for storing at least part of the hydrogen as compressed hydrogen or as hydrogen protons. The system 10 also comprises a generation module 20 for producing electricity 22 from the hydrogen or protons after they have been converted to hydrogen.

The term “grid scale” used herein means a system that is capable of handling several hundred or several thousand megawatts (MW) of electricity. For example, the power needs of the State of South Australia is normally about 2,000 MW but this could increase to about 3,000 MW during hot days of summer. Solar or wind farms could have capacities of several hundred MW and these are connected to the grid. In Queensland, the total power consumption is about 7,500 MW and there may be a multitude of solar or wind farms supplying several hundred MW each to the grid.

The term “renewable energy” used herein refers to, but is not limited to, solar energy, wind energy and wave energy. As discussed in detail later, the energy storage system 10 can also be used in conjunction with other power plants to allow a more efficient operation of a plant.

The term “water” used herein refers to, but not is limited to, water derived from fresh water or seawater, as long as it is applicable for electrolysis to produce hydrogen. For example, the water can be derived from evaporation of fresh water or from desalination of seawater by distillation or by reverse osmosis.

The phrase “with the aid of” used herein intends to define a means that will be used for the present purpose, but does not intend to be limited to the means mentioned. That is, another means for the same purpose may be introduced if desired.

The term “unipolar electrolysis” used herein means electrolysis using a diaphragm-less electrolytic cell having an anode cell and a cathode cell connected by a DC power source and an external conductor, such as is disclosed in U.S. Pat. No. 7,326,329. Unipolar electrolysis of water may also refer to diaphragm type unipolar electrolysis described in U.S. Pat. No. 10,316,416.

As discussed, the renewable energy storage system 10 described herein uses hydrogen as a storage medium. There is a need for viable grid scale storage systems for storing energy produced from renewal energy sources such as solar farms or wind farms because the sun does not shine all the time and the wind does not blow all the time. In contrast, the electrical grid requires that electricity be supplied at all times.

A first part of the renewable energy storage system 10 is a hydrogen generation module 12 for producing hydrogen through electrolysis of water.

In certain embodiments, hydrogen is produced by unipolar electrolysis of water. In these embodiments, the hydrogen generation module 12 comprises one or more unipolar electrolysis apparatus, the apparatus comprising a diaphragm-less anode cell having an anode and an anode solution electrode, the anode being connected to a DC power source; a diaphragm-less cathode cell having a cathode and a cathode solution electrode, the cathode being connected to the DC power source; the anode solution electrode being connected to the cathode solution electrode by an external conductor; and a DC power source connected to the anode and the cathode. The power source provides a DC pulsed current to the anode cell and the cathode cell, and the connections of the cathode solution electrode and the cathode electrode are interchanged to result in the cathode cell behaving like an anode cell in an anode mode, whereby oxidising reactions occur in the water at both anode cell and cathode cell in the anode mode, or the connections between the anode solution electrode and the anode electrode are interchanged to result in the anode cell behaving like the cathode cell in a cathode mode where reducing reactions occur in the water at both anode cell and cathode.

More specifically, the unipolar electrolysis can be conducted as stated in AU 2007257247. In practice, this particular method has some limitations that may impact on its commercial application because chlorine and oxygen may be produced and contaminate the hydrogen if the voltage at the cathode exceeds 0.828 volts and similarly, if the voltage at the anode exceeds 0.401 volts. This can be solved by arranging the cathode cells and the anode cells in series to allow a greater voltage to be achieved without exceeding 0.828 volts at the cathode cell and 0.401 volts at the anode cell. This arrangement allows every cell to produce hydrogen compared to only half of the cells producing hydrogen in conventional seawater electrolysis. Another technique is to have a larger gap with the cathode cells and smaller gap for the anode cells. Experiments have shown that the voltage between electrode in the cathode or anode cells is proportional to the gap. Another technique is to use a catalyst coating on the cathode and anode electrodes that increase the voltage before oxygen or chlorine are produced.

In alternative embodiments, the unipolar electrolysis is conducted as stated in U.S. Pat. No. 10,316,416.

In still further embodiments, the unipolar electrolysis is conducted as stated in U.S. Pat. No. 7,326,329.

The best conventional commercial electrolysis of water requires 53.4 kilowatt-hours of electricity to produce 1 kilogram of hydrogen according to data published by the US National Renewable Energy Laboratory. The applicant has been granted U.S. Pat. No. 10,316,416 titled “Diaphragm Type Electrolytic Cell and a Process for the Production of Hydrogen from the Unipolar Electrolysis of Water” dated Jun. 11, 2019 to produce hydrogen at lower energy from the electrolysis of water. The applicant has also been granted Australian Patent No. 2007257247 and United Kingdom Patent No. GB2452664 titled “Electrolytic activation of water”. The applicant has also been granted U.S. Pat. No. 7,326,329, United Kingdom Patent No. GB2409865, and Australian Patent No. 2004237840 for a diaphragm-less water electrolysis process titled “Commercial Production of Hydrogen from Water”.

The water that is subjected to electrolysis in the hydrogen generation module 12 may be fresh water or sea water, or it may be derived from fresh water or seawater. The water may be produced by desalination of seawater using reverse osmosis. The desalination process may be powered by a renewable energy source which may be the same renewable energy source 14 that is used to power the hydrogen generation module 12 or it may be a separate or stand-alone renewable energy source.

The renewable energy may be solar energy and/or wind energy.

The hydrogen storage module 16 can be any suitable means or apparatus for storing hydrogen, either as hydrogen gas or as hydrogen protons.

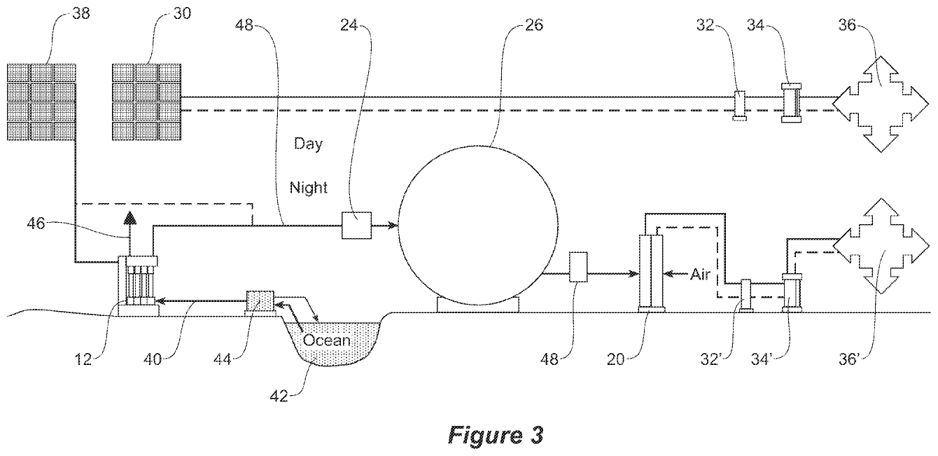

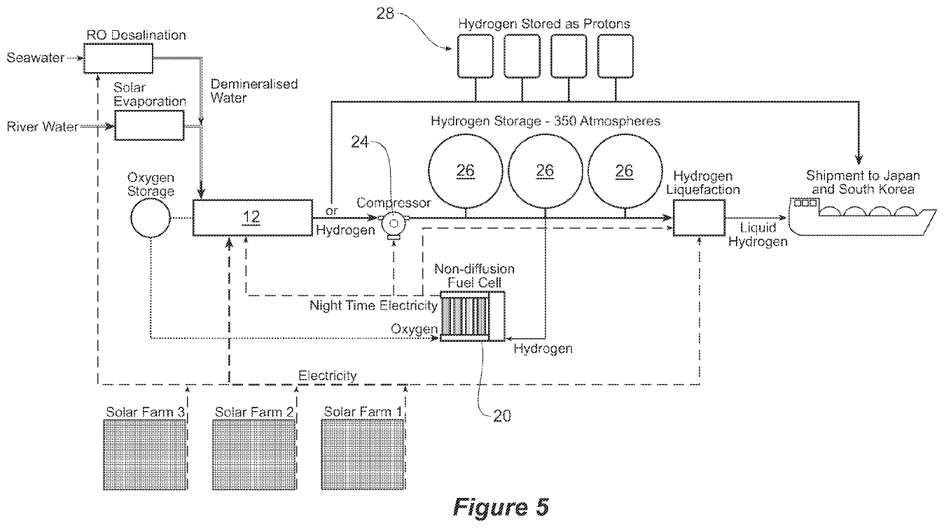

In certain embodiments, the hydrogen is stored as compressed hydrogen and the hydrogen storage module 16 comprises at least one compressor 24 and at least one storage tank 26 (FIGS. 3 and 5). Compressors and storage tanks suitable for use with hydrogen are known in the art and any such known compressors or tanks can be used. By way of example, the hydrogen generated by the hydrogen generation module 12 may be compressed and cooled to 350 atmospheres (5,250 psig) and the hydrogen stored in the tank(s). About 3.91 kwh per kilogram of hydrogen is consumed during the compression of the hydrogen to 350 atmospheres. Tanks with a capacity of 200 tonnes of hydrogen each can be used for the storage of hydrogen. One or more tanks can be used, such as 1, 2, 3, 4 or 5 tanks.

The storage of hydrogen by compression in large quantities is commercially feasible at 350 atmospheres (5,250 psig). Compression to 10,000 psig is also contemplated and may be possible with further improvements or development of tanks.

As shown in FIG. 5, in some embodiments the hydrogen may be further cooled and compressed to liquid hydrogen and then transported. The transported hydrogen may be used as a fuel source in countries in which hydrogen is required (i.e. needs to be imported). This provides a relatively economical way of producing and exporting hydrogen to other markets, such as to Japan and Korea from Australia.

In certain other embodiments, the hydrogen is stored as hydrogen protons and the hydrogen storage module 16 comprises an apparatus 28 for storing hydrogen as hydrogen protons and electrons separately. The apparatus 28 comprises:
a DC power supply;
a hydrogen electrolysis unit comprising a hydrogen tank adapted to contain hydrogen under pressure and in contact with one or more catalyst electrodes contained in the tank, the one or more catalyst electrodes in electrical connection with the DC power supply;
an electron storage unit for storing electrons, the electron storage unit in electrical connection with the DC power supply and separated from the hydrogen electrolysis unit;
wherein the apparatus is also operable in a proton generation mode in which the DC power supply is configured to operate the one or more catalyst electrodes in anode mode to catalyze oxidation of hydrogen in the hydrogen tank to form and store protons on or near the one or more electrodes and store generated electrons in the electron storage unit.

The apparatus 28 for storing hydrogen as hydrogen protons and electrons separately can be operated in a hydrogen recovery mode in which the DC power supply is configured to operate the one or more catalyst electrodes in cathode mode wherein hydrogen protons on the one or more catalyst electrodes are converted to hydrogen under vacuum by recovering the electrons from the electron storage unit, under conditions to remove the hydrogen from a surface of the one or more electrodes as it is formed and remove it from the hydrogen tank.

The one or more catalyst electrodes may be metal impregnated electrodes wherein the metal is selected from one or more of the group consisting of platinum and platinum-iridium.

The electron storage unit is selected from one or more of the group consisting of: a capacitor, an electrolytic system, and oxygen ions contained in electrodes. In certain embodiments, the electron storage unit is a capacitor with high surface area formed from an alloy of metals or oxide of metals. In certain other embodiments, the electron storage unit is an electrolytic system and the cupric-cuprous reaction with an Eₒ of 0.153 volts is used in the chemical storage of the electrons. In certain other embodiments, the electron storage unit is oxygen ions contained in electrodes and the process of generating hydrogen gas results in conversion of the oxygen ions to oxygen.

A suitable apparatus 28 for storing hydrogen as protons and electrons separately is described in WO2019/010519.

It would be readily appreciated by the person skilled in the art that the present invention does not exclude the possibility of employing another storage means in addition to the use of hydrogen as a storage medium.

Any known method or apparatus for generating electricity from hydrogen could be used as a generation module 20. For example, the generation module 20 may comprise a hydrogen fuel cell, a number of which are known in the art and could be used with the with the renewable energy storage system 10. However, in certain beneficial embodiments, the generation module 20 comprises a non-diffusion hydrogen fuel cell. The non-diffusion hydrogen fuel cell comprises a separate anode cell and a separate cathode cell, the anode cell including an anode tank for containing an electrolyte and having an anode electrode immersed therein, means to supply electrolyte to the anode tank and means to supply hydrogen to the anode tank, the cathode cell including a cathode tank for containing the electrolyte and having an cathode electrode immersed therein, means to supply electrolyte to the cathode tank and means to supply an oxidant to the cathode tank, means to withdraw reacted electrolyte from the anode tank and to supply it to the cathode tank, means to withdraw reacted electrolyte from the cathode tank and to supply it to the anode tank, each of the anode electrode and the cathode electrode having a central current collector and a coating of catalyst thereon, each of the anode electrode and the cathode electrode having a first end and a second end, means to connect the first end of the anode electrode and the first end of the cathode electrode to a first electrical load outside of the fuel cell, and means to connect the second end of the anode electrode and the second end of the cathode electrode to a second electrical load.

The second electrical load may comprise a semiconductor membrane or a diode.

A suitable non-diffusion hydrogen fuel cell is described in U.S. Pat. No. 6,475,653.

Also disclosed herein is a method of storing renewable energy by use of hydrogen as a medium, which comprises:

producing hydrogen by unipolar electrolysis of water and with the use of renewable energy; and

storing at least part of the hydrogen as compressed hydrogen or hydrogen protons.

The method may also comprise converting at least part of the stored hydrogen or protons after they have been converted to hydrogen to produce electricity.

A specific example of the use of the renewable energy storage system 10 for either solar or wind energy is shown in FIG. 3 and described below.

A 2,000 megawatt (MW) solar farm 30 supplies electricity during daytime. The electricity is passed through an inverter 32 to convert it to three phase power and then a high voltage transformer 34 delivers 1,900 MW power to the grid 36.

A 1,931 MW solar farm 38 is used to electrolyse water 40 by unipolar electrolysis in hydrogen generation module 12. The water 40 is produced by the desalination of seawater 42 using a reverse osmosis unit 44. Seawater may be the best source of water at locations where fresh water is scarce.

Oxygen 46 from the unipolar electrolysis of water is released to the atmosphere while hydrogen 48 is compressed to 350 atmospheres using compressor 24 and stored in large tanks. Hydrogen may also be stored as hydrogen protons but in this example, compression is used. About 30 kilowatt-hours (kwh) per kilogram of hydrogen is consumed in the unipolar electrolysis. In conventional water electrolysis, the consumption of electricity is about 53.4 kwh per kilogram of hydrogen produced. About 3.91 kwh per kilogram of hydrogen is consumed during the compression of the hydrogen to 350 atmospheres.

Four tanks 26 with capacity of 200 tonnes of hydrogen each are used for the storage of hydrogen.

During night-time, hydrogen is decompressed 48 to fuel the non-diffusion hydrogen fuel cell 20 operating at an efficiency of about 80%. About 2.346 kwh per kilogram of hydrogen is recovered during the decompression process.

About 1,560 MW is produced to supply electricity during night-time and after converting to three phase and high voltage using inverter 32′ and transformer 34′, the 1,482 MW power is delivered to the grid 36′ to supply electricity during night-time.

This example of a grid scale renewal energy storage and release system involves the following technologies:
1. The production of hydrogen by the unipolar electrolysis of water;
2. The storage of at least part of the hydrogen produced as compressed hydrogen; and
3. The conversion of hydrogen with the aid of a non-diffusion hydrogen fuel cell to produce electricity.

The grid scale renewal energy storage and release system 10 can provide efficient and grid scale storage of energy for solar and wind energy using hydrogen and for the transport of hydrogen. The benefit of this system is shown in the following. The wholesale price of electricity in June 2018 of the different states of Australia are shown in Table 1:

TABLE 1
Wholesale price of electricity in selected Australian
states, A$ per Megawatt hour - MWH

| | |
|---|---|
| South Australia | 114.16 |
| Victoria | 100.12 |
| New South Wales | 88.06 |
| Tasmania | 82.73 |
| Queensland | 76.92 |

Table 2 shows the lower cost of electricity for South Australia when the grid scale storage of this application is applied to South Australia:

TABLE 2
Estimated cost of Send off Cartwheel Hydrogen Grid Scale Storage

| | |
|---|---|
| 1. Energy used in electrolysing seawater, kilowatt-hours/kilogram | 30 |
| 2. Energy used in compressing hydrogen to 350 atmospheres, kwh/kg | 3.91 |
| 3. Energy losses in electric transmission and hydrogen pipelines, kwh/kg | 1 |
| 4. Energy recovery during decompression, 60% | 2.346 |
| 5. Total energy required per kilogram of hydrogen, kwh/kg | 32.564 |
| 6. Hydrogen required for 12 hours, tonnes | 702 |
| 7. Energy content of 1 kilogram of hydrogen, kwh | 33.33 |
| 8. Efficiency of Cartwheel Hydrogen Fuel Cells, % | 80 |
| 9. Electric power required to produce 702 tonnes of hydrogen, kilowatt-hours/day | 21,060,000 |
| 10. Electric power required for compression and losses, kwh/day | 1,799,928 |
| 11. Total power required per day, kwh | 22,859,928 |
| 12. Capacity required of the solar farm, MW | 1905 |
| 13. Cost of solar power per kwh, $/kwh | $0.05 |
| 14. Total annual cost of power, $ | $417,193,686.00 |
| 15. Total Energy send-off, kwh/year | 6,832,116,720 |
| 16. Total Energy send off in MW | 1560 |
| 17. Estimated cost of electric lines, electrolysis, pipelines, storage, etc | $2,500,000,000 |
| 18. Assumed interest rate, % | 6 |
| 19. Assumed amortisation period, years | 25 |
| 20. Interest payment per year, $ | $75,000,000 |
| 21. Amortisation per year, $ | $100,000,000 |
| 22. Total amortisation and interest per year, $ | $175,000,000 |
| 23. Total cost of Hydrogen Grid Storage power per year, $ | $592,193,686.00 |
| 24. Total cost of Grid Storage per Kilowatt-hour, $ | $0.08668 |
| 25. Average cost of Power with Grid Storage, $/MWH | $68.36 |
| Energy Efficiency | |
| 1. Energy produced per year, kwh | 6,832,116,720 |
| 2. Energy required per year, kwh | 8,343,873,720 |
| 3. Energy efficiency, % | 81.88 |

Table 1 and Table 2 show the substantial reduction in the electricity cost in South Australia when the grid scale renewal energy storage and release system 10 is applied to the renewable energy of South Australia. The grid scale renewal energy storage and release system 10 will provide an efficient and reliable electric power system. The projected efficiency is 81.88% as shown on Table 2.

As discussed, the grid scale renewal energy storage system 10 can also be used for the export of hydrogen. In an example, the facilities are located in the mid-north of South Australia. Electricity is supplied from solar farms or wind farms and transmitted to the coast such as Cape Blanch where desalinated water is electrolysed using unipolar electrolysis. Part of the hydrogen is liquefied and sent to Japan or Asia while part of the hydrogen is piped to near Port Augusta where it is stored either compressed in tanks or stored as hydrogen protons. The hydrogen is then recovered and fuels a non-diffusion fuel cell to produce electricity for the grid at nighttime.

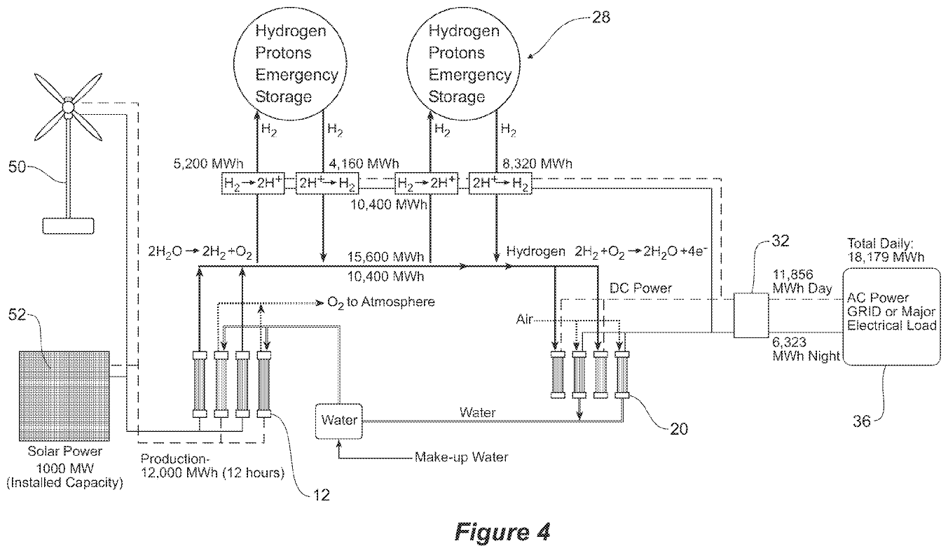

A further example of the grid scale renewal energy storage system 10 is shown in FIG. 4. In FIG. 4, all the renewable electricity is used to electrolyse water to produce hydrogen. This method may be more efficient compared to the example of the grid scale renewal energy storage system 10 shown in FIG. 3. The renewable electric power may come from wind 50 or solar 52 energy and the hydrogen is stored as hydrogen protons. Part of the storage is for daytime and night time supply of electricity but another storage is shown for emergency electricity required for the difference of solar radiation during summer and winter or when there are extended days of poor sunshine. The hydrogen recovered is then used to fuel a non-diffusion hydrogen fuel cell.

With Australian having a very high level of solar radiation, there is common talk of exporting this natural resource in the form of hydrogen. ACIL Allen Consulting prepared a report—“Opportunities for Australia from Hydrogen Exports” for the Australian Renewable Energy Agency and estimated the opportunities for the export of hydrogen by 2040 as set out in Table 3.

TABLE 3
Projected global demand for hydrogen (tonnes) for 2040 (max).

| | |
|---|---|
| Japan | 9,573,000 |
| South Korea | 5,304,000 |
| Singapore | 481,000 |
| China | 40,989,000 |
| Rest of world | 25,758,000 |
| Total | 82,105,000 |

According to WORLD Data Info, the total fossil fuel requirements of Japan are 1,840.38 bn kwh per year and this is equivalent to 55,216,921 tonnes of hydrogen per year as the potential for hydrogen exports to Japan.

FIG. 5 shows an example of using of grid scale renewal energy storage system 10 and exporting hydrogen from any part of Australia. This method uses the grid scale renewal energy storage system 10 to efficiently produce hydrogen for export. Water feedstock may be from the desalination of seawater or from the distillation of river or fresh water. Electricity may come usually from solar farms but some may come from wind farms. The water is electrolyzed in hydrogen generation module 12 using unipolar electrolysis and the hydrogen produced may be stored by two methods, namely by compression to 350 atmospheres or higher and storage of compressed hydrogen in tanks 26 or by storing the hydrogen as hydrogen protons in apparatus 28 for storing hydrogen as hydrogen protons. With compression, the hydrogen is compressed using compressor 24 and cooled and then stored in tanks 26. The hydrogen is then further cooled and compressed to liquid hydrogen and this is the form that it is shipped to Japan and Asia. With hydrogen proton storage, the electrons are separated and stored separately.

As discussed, the energy storage system 10 described herein is particularly suitable for storage of energy obtained from renewable sources, such as solar, wind and wave. However, the energy storage system 10 can also be used in conjunction with other energy sources to allow them to work more efficiently. In most electrical grid systems, it is efficient to run the power generators continuously; however, the grid load varies from peak loads to off-peak low loads. The grid scale energy storage system 10 described herein may be applied also to hydro plants, nuclear plants and thermal (e.g. coal and natural gas) power plants, to store energy during peak periods and release the energy during off-peak periods, allowing the power plants to operate more efficiently.

It will be apparent from the foregoing that two major applications of the renewal energy storage system 10 described and claimed herein are in the provision of an efficient grid scale energy storage system to provide reliable and continuous electricity from renewable solar or wind energy and the other is in the export of hydrogen. Australia has the highest solar radiation in its region and this energy can be converted to hydrogen and exported to Asian countries north of Australia at a lower price and larger scale using the renewal energy storage system 10 that existing conventional hydrogen technologies cannot match. The lower price and larger scale will allow the world to transition from carbon fuels to clean energy in electric power generation and in the world trade of hydrogen.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A renewable energy storage system which uses hydrogen as a storage medium, the system comprising:
a hydrogen generation module for producing hydrogen through electrolysis of water wherein the hydrogen generation module is powered by one or more renewable energy sources;
a hydrogen storage module for storing at least part of the hydrogen as compressed hydrogen or as hydrogen protons; and
a generation module for producing electricity from the hydrogen or protons after they have been converted to hydrogen.

2. The system as claimed in claim 1, wherein the hydrogen generation module comprises one or more unipolar electrolysis apparatus.

3. The system as claimed in claim 2, wherein the unipolar electrolysis apparatus comprises:
a diaphragm-less anode cell having an anode and an anode solution electrode, the anode being connected to a DC power source;
a diaphragm-less cathode cell having a cathode and a cathode solution electrode, the cathode being connected to the DC power source;
the anode solution electrode being connected to the cathode solution electrode by an external conductor;
and a DC power source connected to the anode and the cathode.

4. The system as claimed in claim 2, wherein the cathode cells and anode cells are arranged in series to allow the voltage at each of the cathode cells not to exceed 0.828 volts and the voltage at each of the anode cells not to exceed 0.401 volts.

5. The system as claimed in claim 1, wherein the hydrogen storage module comprises an apparatus for storing hydrogen as hydrogen protons and electrons separately, the apparatus comprising:
a DC power supply;
a hydrogen electrolysis unit comprising a hydrogen tank adapted to contain hydrogen under pressure and in contact with one or more catalyst electrodes contained in the tank, the one or more catalyst electrodes in electrical connection with the DC power supply; and
an electron storage unit for storing electrons, the electron storage unit in electrical connection with the DC power supply and separated from the hydrogen electrolysis unit;
wherein the apparatus is also operable in a proton generation mode in which the DC power supply is configured to operate the one or more catalyst electrodes in anode mode to catalyze oxidation of hydrogen in the hydrogen tank to form and store hydrogen protons on or near the one or more electrodes and store generated electrons in the electron storage unit.

6. The system as claimed in claim 5, wherein the apparatus for storing hydrogen as hydrogen protons and electrons separately is operable in a hydrogen recovery mode in which the DC power supply is configured to operate the one or more catalyst electrodes in cathode mode wherein hydrogen protons on the one or more catalyst electrodes are converted to hydrogen under vacuum by recovering the electrons from the electron storage unit, under conditions to remove the hydrogen from a surface of the one or more electrodes as it is formed and remove it from the hydrogen tank.

7. The system as claimed in claim 5, wherein the one or more catalyst electrodes are metal impregnated electrodes wherein the metal is selected from one or more of the group consisting of platinum and platinum-iridium.

8. The system as claimed in claim 5, wherein the electron storage unit is selected from one or more of the group consisting of: a capacitor, an electrolytic system, and oxygen ions contained in electrodes.

9. The system as claimed in claim 1, wherein the generation module comprises a hydrogen fuel cell.

10. The system as claimed in claim 9, wherein the hydrogen fuel cell is a non-diffusion hydrogen fuel cell comprising a separate anode cell and a separate cathode cell, the anode cell including an anode tank for containing an electrolyte and having an anode electrode immersed therein, means to supply electrolyte to the anode tank and means to supply fuel to the anode tank, the cathode cell including a cathode tank for containing the electrolyte and having an cathode electrode immersed therein, means to supply electrolyte to the cathode tank and means to supply an oxidant to the cathode tank, means to withdraw reacted electrolyte from the anode tank and to supply it to the cathode tank, means to withdraw reacted electrolyte from the cathode tank and to supply it to the anode tank, each of the anode electrode and the cathode electrode having a central current collector and a coating of catalyst thereon, each of the anode electrode and the cathode electrode having a first end and a second end, means to connect the first end of the anode electrode and the first end of the cathode electrode to a first electrical load outside of the fuel cell, and means to connect the second end of the anode electrode and the second end of the cathode electrode to a second electrical load.

11. The system as claimed in claim 10, wherein the second electrical load comprises a semiconductor membrane or a diode.

12. The system as claimed in claim 1, wherein the renewable energy is selected from solar energy and wind energy.

13. The system as claimed in claim 1, wherein the water is derived from fresh water or seawater.

14. A method of storing renewable energy by use of hydrogen as a medium, which comprises:
producing hydrogen by electrolysis of water and with the use of renewable energy; and
storing at least part of the hydrogen as compressed hydrogen or hydrogen protons.

15. The method as claimed in claim 14, further comprising converting at least part of the stored hydrogen or protons after they have been converted to hydrogen to produce electricity.

16. The method as claimed in claim 14, comprising producing hydrogen by unipolar electrolysis of water and with the use of renewable energy.

17. The method as claimed in claim 14, comprising storing hydrogen as compressed hydrogen.

18. The method as claimed in claim 17, comprising compressing hydrogen to at least 350 atmospheres.

19. The method as claimed in claim 14, comprising storing hydrogen as hydrogen protons.

20. The method as claimed in claim 14, comprising converting at least part of the stored hydrogen to produce electricity in a non-diffusion hydrogen fuel cell.

21. (canceled)

22. (canceled)
